(19) United States
(12) Patent Application Publication
(10) Pub. No.: US 2006/0182052 A1
(43) Pub. Date: Aug. 17, 2006

(54) System for providing internet protocol broadcast services and a method thereof

(75) Inventors: Won-Shik Yoon, Suwon-si (KR); Chang-Sup Shim, Seoul (KR); Yun-Je Oh, Yongin-si (KR); Tae-Sung Park, Yongin-si (KR); Sang-Hyun Doh, Hwaseong-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/340,963

(22) Filed: Jan. 26, 2006

(30) Foreign Application Priority Data
Feb. 15, 2005 (KR) 2005-12341

(51) Int. Cl. H04H 1/00

(52) U.S. Cl. 370/312

(57) ABSTRACT

Disclosed is an IP-based broadcast service system capable of reducing the channel zapping or changing time and the waste of bandwidths during frequent channel changes such as channel surfing. A broadcast server for providing broadcast services generates both high-quality broadcast data and low-quality broadcast data of each TV channel. The broadcast server provides the low-quality broadcast data during a simple channel surfing. When a viewer selects a channel to view, the broadcast server then provides the high-quality broadcast data of the selected channel.

### CLAIM OF PRIORITY

This application claims priority to an application entitled “System for Providing Internet Protocol Broadcast Services,” filed with the Korean Intellectual Property Office on Feb. 15, 2005 and assigned Serial No. 2005-12341, the contents of which are incorporated herein by reference.

### BACKGROUND OF THE INVENTION

1. Field of the Invention

The present invention relates to a system for providing broadcast services, and more particularly to a system for providing Internet protocol broadcast services in an Ethernet-based passive optical network.

2. Description of the Related Art

Generally, IP-based broadcast networks need data transmission rates in excess of 100 Mbps in order to effectively provide subscribers with large-amount, high-speed data services and realtime digital broadcast/video services. Existing broadband technologies such as xDSL and cable modems with merely up to 50 Mbps transmission rate cannot meet the demand for higher bandwidths to offer such data services. Thus, present researchers are actively pursuing the development of the high-speed data transmission networks capable of providing high-speed, large-amount data services and realtime digital broadcast/video services. As alternative technology for transmitting data at higher rate, optical networks, particularly the cost-effective passive optical networks (PONs) are attracting attention of the industry.

There are various PONs which include an ATM-based PON (ATM-PON), a wavelength division multiplexed PON (WDM-PON) and an Ethernet-based PON (EPON). As the most economic solution to bring high-speed fiber optic services to homes, an FTTH (Fiber To The Home) architecture of the EPON has been suggested and deployed.

Ethernet-based PONs have been developed initially for communication data transmissions. The EPONs use different wavelengths for each direction (i.e., 1550 nm) for the downstream from the OLT (Optical Line Terminal) to the ONUs/ONTs (Optical Network Units/Optical Network Terminals) and 1310 nm for the upstream from the ONUs to the OLT to transmit 1.25 Gbps Ethernet signals.

Current IP-based broadcast networks encode broadcast signals provided from a satellite receiver connected to a broadcast TV headend or from a content/program provider into MPEG2/4 or H.264 frames to provide video services to the subscriber terminals. Each subscriber can receive video data at a selected channel through an IP set-top box (“STB”) connected to a TV receiver or a computer in the subscriber's home. The term “IP-based broadcast services” is supposed to have the same meaning as “IP-based TV services.”

In existing digital broadcast systems such as satellite TV or CATV, broadcasting signals of all channels are transmitted to the set-top box (STB) of each subscriber terminal. When a subscriber makes a channel change, the STB can directly transmit broadcast signals of a newly selected channel to the subscriber's TV.

Unlike the digital broadcast systems that performs a channel bifurcation at the STB, IP-based broadcast systems performs the channel bifurcation at network equipment. When a subscriber makes a channel change, the STB cannot directly provide broadcast data of a newly selected channel to the subscriber's terminal. The STB has to receive the broadcast data from the network equipment using a protocol such as IGMP (Internet Group Management Protocol) or PIM (Protocol Independent Multicast).

A general system for providing IP-based TV broadcast services will be explained in detail with reference to FIG. 1 that illustrates a general Ethernet-based passive optical network.

Referring to FIG. 1, a broadcast server (headend) 100 converts broadcast signals provided from program providers into MPEG2/4 streams or H.264 frames by channels and transmits broadcast data encapsulated into IP packets to an OLT 104 via a router 102.

The OLT (Optical Line Terminal) 104 controls registration and management of a plurality of subscriber units (ONUs/ONTs) 106 through 802.3ah protocol. The OLT 104 also controls transmission and receiving of broadcast data offered from the broadcast server 100.

STBs 108, 110 and 112 connected to the ONUs/ONTs 106 are connected to TV receivers at homes or offices and convert the received broadcast data into broadcast signals. When a user makes a channel change, a corresponding STB receives video data of the newly selected channel using an IGMP protocol and transmits the received data to the user's TV or PC.

In the above broadcast system, a channel bifurcation occurs at the network equipment. Accordingly, the STBs 108, 110 and 112 use a protocol such as IGMP or PIM to inform the IP network equipment of the broadcast channel selected by a user. In other words, delays occur when processing such a protocol to provide IP-based broadcast services. Such delays include a network delay caused to process a protocol such as IGMP (i.e., delay in channel zapping or changing time) and MPEG2/4 decoding delay at the STBs 108, 110 and 112.

When a subscriber of STB 1 108 selects channel A that is not viewed by any other subscriber in the network to which STB 1 108 pertains, STB 1 108 receives broadcast data of channel A from an RP (Randevous Point) within the router 102 using a protocol such as IGMP or PIM.

When a subscriber of STB 2 110 selects channel A that is viewed by one or more other subscribers in the network to which STB 2 110 pertains, STB 2 110 needs to transmit or receive IGMP messages only to and from the corresponding ONU/ONT 106. Accordingly, subscribers of STB 2 110 can receive channel A in a shorter time than those of STB 1 108.

As explained above, if a subscriber selects a specific channel that is viewed by one or more other subscribers in the same network, no additional bandwidth is needed to receive the selected channel. On the other hand, if a subscriber selects a channel that is not viewed by any other subscriber in the same network, an additional bandwidth is required to receive the selected channel.

Viewers generally select a desired broadcast channel by channel surfing using the channel up/down keys provided on a TV remote controller, rather than by pressing the numeric buttons on the remote controller directly.

While surfing the TV channels, viewers receive all channels, even the channels that they do not wish to view. They often channel surf to find out what program is being broadcasted on each channel. In IP TV broadcast systems, it is necessary to process protocols such as IGMP or PIM between the IP set-top box and the network equipment every time the channel changes, which causes a delay in jumping between channels. Whenever each channel is selected even for a short time by channel surfing, an additional bandwidth is required to provide broadcast data of each channel. Also, excessive channel surfing increases the system load.

### SUMMARY OF THE INVENTION

Accordingly, the present invention has been made to solve the above-mentioned problems occurring in the prior art and provide additional advantages by providing an IP-based broadcast service system capable of reducing the channel zapping or changing time and the waste of bandwidths during frequent channel change such as channel surfing.

In accordance with one aspect of the present invention, a system for providing IP-based broadcast services is provided. The system includes: a broadcast server for generating both high-quality broadcast data and low-quality broadcast data of each TV channel and sending the low-quality broadcast data to a router; an OLT (Optical Line Terminal) for receiving the low-quality broadcast data from the broadcast server and forwarding the low-quality broadcast data to a set-top box to an ONU/ONT (Optical Network Unit/Optical Network Terminal); and the set-top box for storing the low-quality broadcast data received from the OLT, when a channel change is detected, providing low-quality broadcast data of the newly selected channel, when corresponding high-quality broadcast data is requested, sending an IGMP join message to the router to receive the high-quality broadcast data.

### BRIEF DESCRIPTION OF THE DRAWINGS

The above features and advantages of the present invention will be more apparent from the following detailed description taken in conjunction with the accompanying drawings, in which:

FIG. 1 illustrates a conventional Ethernet-based passive optical network;

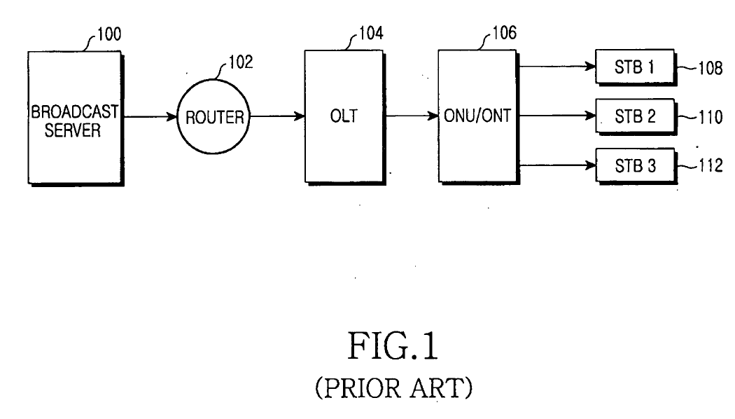

FIG. 2 illustrates a system for providing internet protocol broadcast services according to an aspect of the present invention; and

FIG. 3 illustrates a system for providing internet protocol broadcast services according to another aspect of the present invention.

### DETAILED DESCRIPTION OF THE INVENTION

Hereinafter, several aspects of the present invention will be described with reference to the accompanying drawings. For purposes of clarity and simplicity, a detailed description of known functions and configurations incorporated herein will be omitted, as it may make the subject matter of the present invention unclear.

In general, viewers continuously change channels to find a channel on which a desired program is being broadcasted or obtain information as to what program is broadcast on a particular channel. Therefore, it is not necessary to provide high-quality broadcast data during channel surfing. According to the present invention, low-quality broadcast data of each channel is provided while a viewer is simply surfing channels.

To this end, the broadcast server generates low-quality broadcast data in addition to high-quality broadcast data of each channel. The broadcast server provides the low-quality broadcast data during channel surfing. When a viewer selects a channel to view, the broadcast server provides the high-quality broadcast data.

The present invention provides several aspects for providing low-quality broadcast data during channel surfing and high-quality broadcast data as a channel is selected.

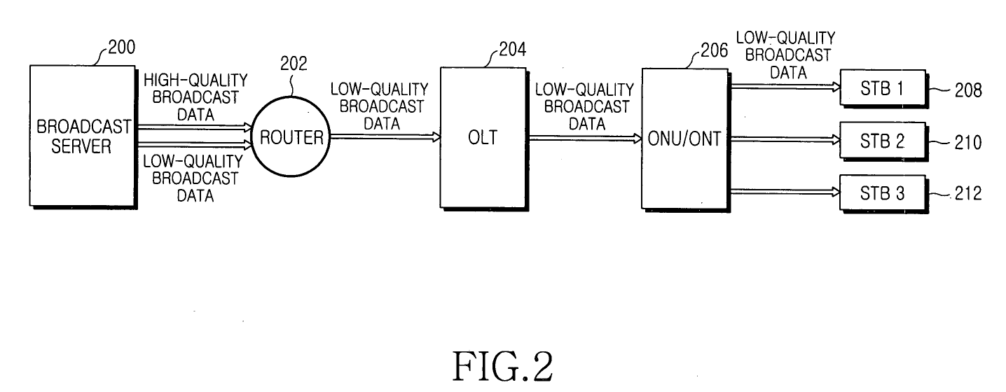

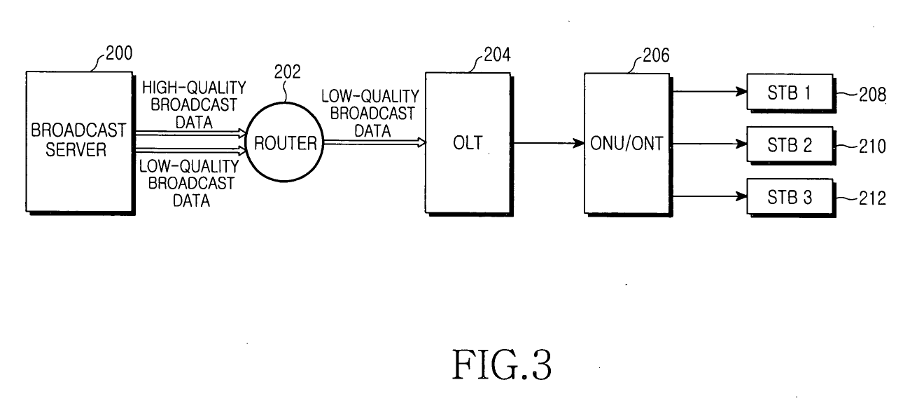

Hereinafter, a process of providing broadcast services according to the present invention will be explained with reference to FIGS. 2 and 3. FIG. 2 illustrates a system for providing internet protocol broadcast services according to one aspect of the present invention. In this system, a broadcast server 200 generates low-quality broadcast data and provides the data to STBs 208, 210 and 212 during channel surfing. FIG. 3 illustrates a system for providing internet protocol broadcast services according to another aspect of the present invention. In this system, the broadcast server 200 generates low-quality broadcast data and provides the data to an OLT 204 during channel surfing.

The broadcast server 200 generates both high-quality broadcast data and low-quality broadcast data of each channel. The low-quality broadcast data refers to small amounts of broadcast data merely showing which program is being broadcast on each channel.

The low-quality broadcast data does not require high bandwidth. In addition, the low-quality broadcast data can reduce the time to decode MPEG-2 or MPEG-4 which causes a delay in channel change at the STBs 208, 210 and 212.

Since the broadcast server 200 generates low-quality broadcast data in addition to corresponding high-quality broadcast data, an additional multicast address is needed. Unlike a unicast address allocated to a single subscriber or network equipment, a multicast address allocated to a broadcast channel or group has a relatively larger address pool. Accordingly, the present invention is capable of generating additional low quality broadcast data without much difficulty.

Bandwidths required for low-quality broadcast data of all TV channels are not more than the bandwidth required for high-quality broadcast data of a single channel. In other words, high bandwidths are not required to send the low-quality broadcast data to the STBs 208, 210 and 212 or the ONU/ONT 206 connected to the STBs or to the LHR (Last Hop Router) of the router 202.

According to one aspect of the present invention, as illustrated in FIG. 2, the high-quality broadcast data and low-quality broadcast data of each channel are simultaneously forwarded to the router 202. The low-quality broadcast data is further forwarded to the STBs 208, 210 and 212 via the OLT 204 and the ONU/ONT 206.

Since the low-quality broadcast data is provided to the STBs 208, 210 and 212, an exchange protocols for multicast to the superordinate router is not necessary. While there is little delay in jumping between channels because a channel bifurcation occurs at the STBs 208, 210 and 212, sufficient bandwidth is available to carry the broadcast data to the subscribers.

When a user changes channel using the STB 208, 210 or 212 or the STB remote controller, low-quality broadcast data of the newly selected channel is provided to a terminal connected to the STB 208, 210 or 212.

If no additional channel change is made for a predetermined period of time, an IGMP join message will be forwarded to the OLT 204 so that high-quality broadcast data of the selected channel may be provided to the terminal.

Alternatively, the user can press a button provided on the remote controller and intentionally and manually choose to receive the high-quality broadcast data. In other words, if no additional channel change is made for the predetermined time period, the above process of providing the high-quality broadcast data will be performed automatically or upon the pressing of the specific button on the remote controller.

According to another aspect of the present invention, as illustrated in FIG. 3, the broadcast server 200 provides low-quality broadcast data of all TV channels to the OLT 204 through the router 202. Since the channel bifurcation occurs at the OLT 204, the channel zapping or changing time can be greatly reduced.

When a user makes a channel change using the STB 208, 210 or 212 or the STB remote controller, the STB 208, 210 or 212 sends an IGMP join message to the OLT 204 to request low-quality broadcast data of the newly selected channel. Then the OLT 204 forwards the requested low-quality broadcast data to the corresponding STB 208, 210 or 212 through the ONU/ONT 206.

If no additional channel change is made for a predetermined period of time, the STB sends another IGMP join message to the OLT 204 so that high-quality broadcast data of the currently selected channel can be provided to the terminal.

Alternatively, the user can press a button provided on the remote controller and intentionally and manually choose to receive the high-quality broadcast data. In other words, if no additional channel change is made for the predetermined time period, the above process of providing the high-quality broadcast data will be performed automatically or upon the pressing of the specific button on the remote controller.

As explained above, the broadcast server for providing broadcast services generates both high-quality broadcast data and low-quality broadcast data of each TV channel. The broadcast server provides the low-quality broadcast data during a simple channel surfing. When a viewer selects a channel to view, the broadcast server then provides the high-quality broadcast data of the selected channel. The use of low-quality broadcast data during channel surfing can greatly reduce the channel zapping or changing time. The STB that receives the low-quality broadcast data decodes small-size video, thereby reducing the time to decode MPEG-2 or MPEG-4 which causes a delay in channel changes. It is not necessary to provide high-quality broadcast data to the STB whenever the channel changes. The high-quality broadcast data that requires high bandwidth is provided only when a channel is finally selected, which reduces the waste of bandwidths.

Although disclosed aspects of the present invention have been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A system for providing IP-based broadcast services, comprising:
a broadcast server for generating both high-quality broadcast data and low-quality broadcast data of each TV channel and sending both broadcast data through a router;
an OLT (Optical Line Terminal) for receiving the low-quality broadcast data from the broadcast server and forwarding the low-quality broadcast data to a set-top box through an ONU/ONT (Optical Network Unit/Optical Network Terminal); and
the set-top box for storing the low-quality broadcast data received from the OLT, providing low-quality broadcast data of the newly selected channel when a channel change is detected, and sending an IGMP join message to the router to receive the high-quality broadcast data when a request for corresponding high-quality broadcast data is made.

2. The system as claimed in claim 1, wherein said request for high-quality broadcast data is made when no additional channel change is detected for a predetermined period of time.

3. The system as claimed in claim 1, wherein said request for high-quality broadcast data is made manually.

4. The system as claimed in claim 1, wherein said low quality-broadcast data is small amounts of broadcast data merely showing which program is being broadcast on each channel.

5. The system as claimed in claim 1, wherein exchange protocols for a multicast to a superordinate router is not necessary

6. A system for providing IP-based broadcast services, comprising:
a broadcast server for generating both high-quality broadcast data and low-quality broadcast data of each TV channel and sending both broadcast data through a router;
a router for receiving the low-quality broadcast data from the broadcast server, forwarding the low-quality broadcast data to an OLT (Optical Line Terminal) and providing the requested high-quality broadcast data when an IGMP join message requesting high-quality broadcast data is received;
the OLT for receiving and storing the low-quality broadcast data, providing the requested low-quality broadcast data when an IGMP join message requesting the low-quality broadcast data is received, and sending the IGMP join message to the router when an IGMP join message requesting the high-quality broadcast data is received; and
a set-top box for sending an IGMP join message requesting low-quality broadcast data of the newly selected channel to the OLT through an ONU/ONT (Optical Network Unit/Optical Network Terminal) when a channel change is detected, and sending an IGMP join message requesting the high-quality broadcast data when a request for high-quality broadcast data is made.

7. The system as claimed in claim 6, wherein said request for high-quality broadcast data is made when no additional channel change is detected for a predetermined period of time.

8. The system as claimed in claim 6, wherein said request for high-quality broadcast data is made manually.

9. The system as claimed in claim 6, wherein said low quality-broadcast data is small amounts of broadcast data merely showing which program is being broadcast on each channel.

10. The system as claimed in claim 6, wherein channel zapping time is reduced.

11. A method for providing IP-based broadcast services comprising steps of:
generating both high-quality broadcast data and low-quality broadcast data of each TV channel and transmitting both broadcast data to a router;
providing the low quality broadcast data from the router to an OLT (Optical Line Terminal);
providing the low quality broadcast data from OLT to a set-top box through an ONU/ONT (Optical Network Unit/Optical Network Terminal);
providing an IGMP join message to the router to receive the high-quality broadcast data, when a requests for high-quality broadcast data is made; and
providing the high quality broadcast data, as requested.

12. The method claimed in claim 11 further comprising steps of:
storing the low quality broadcast data received from the ONU/ONT at the set-top box after receiving from the OLT and providing the low-quality broadcast data of newly selected channel, when a channel change is detected, prior to providing the IGMP join message to the router.

13. The method claimed in claim 12 further comprising the step of rendering exchange protocols for a multicast to a superordinate router unnecessary.

14. The method claimed in claim 12, wherein the step of requesting for high-quality broadcast data is made when no additional channel change is detected for a predetermined time.

15. The method claimed in claim 12, wherein the step of requesting for high-quality broadcast data is made manually.

16. The method claimed in claim 11 further comprising a step of storing the low-quality broadcast data at OLT after receiving the low-quality broadcast data from the router.

17. The method claimed in claim 16, wherein the step of providing the low quality broadcast data to a set-top box through an ONU/ONT (Optical Network Unit/Optical Network Terminal) from the OLT is made when an IGMP join message requesting the low quality broadcast data is received by the OLT.

18. The method claimed in claim 17, wherein the step of requesting for high-quality broadcast data is made when an additional channel change is detected for a predetermined time.

19. The method claimed in claim 17, wherein the step of requesting for high-quality broadcast data is made manually.

20. The method claimed in claim 17 further comprising a step of reducing channel zapping time.
